(19) United States
(12) Patent Application Publication
(10) Pub. No.: US 2022/0225682 A1
(43) Pub. Date: Jul. 21, 2022

(54) AEROSOL PROVISION DEVICE

(71) Applicant: Nicoventures Trading Limited, London (GB)

(72) Inventors: Walid Abi Aoun, London (GB); Thomas Alexander John Woodman, London (GB); Julian Darryn White, London (GB); Martin Daniel Horrod, London (GB)

(21) Appl. No.: 17/596,312

(22) PCT Filed: Jun. 23, 2020
(86) PCT No.: PCT/EP2020/067563

§ 371 Date: Dec. 7, 2021

(30) Foreign Application Priority Data
Jun. 28, 2019 (GB) 1909343.4

(51) Int. Cl. A24F 40/465; A24F 40/20; A24F 40/57; H05B 6/10

(52) U.S. Cl. CPC A24F 40/465; H05B 6/108; A24F 40/57; A24F 40/20

(57) ABSTRACT

An aerosol provision device having a heating zone for receiving at least a portion of an article including aerosolizable material, an outlet through which aerosol is deliverable from the heating zone to a user in use, and heating apparatus for causing heating of the article when the article is at least partially located within the heating zone to thereby generate the aerosol. The heating apparatus is configured to, during a heating session, cause heating of a first portion of the aerosolizable material to a temperature sufficient to aerosolize a component of the first portion of the aerosolizable material, and heating of a second portion of the aerosolizable material to a temperature sufficient to aerosolize a component of the second portion of the aerosolizable material. The heating apparatus is configured to cause the heating of the first portion before or more quickly than the heating of the second portion.

### PRIORITY CLAIM

The present application is a National Phase entry of PCT Application No. PCT/EP2020/067563, filed Jun. 23, 2020, which claims priority from Great Britain Patent Application No. 1909343.4, filed Jun. 28, 2019, which is hereby fully incorporated herein by reference.

### TECHNICAL FIELD

The present invention relates to aerosol provision devices, to aerosol provision systems comprising aerosol provision devices and articles comprising aerosolizable material, and to methods of heating aerosolizable material. The aerosol provision devices may be tobacco heating products, for example.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

A first aspect of the present invention provides an aerosol provision device, comprising: a heating zone for receiving at least a portion of an article comprising aerosolizable material; an outlet through which aerosol is deliverable from the heating zone to a user in use; and heating apparatus for causing heating of the article when the article is at least partially located within the heating zone to thereby generate the aerosol; wherein the heating apparatus is configured to, during a heating session, cause: heating of a first portion of the aerosolizable material, that is located at a first location in the heating zone when the article is at least partially located within the heating zone, to a temperature sufficient to aerosolize a component of the first portion of the aerosolizable material without burning the first portion of the aerosolizable material, and heating of a second portion of the aerosolizable material, that is located at a second location in the heating zone when the article is at least partially located within the heating zone, to a temperature sufficient to aerosolize a component of the second portion of the aerosolizable material without burning the second portion of the aerosolizable material, wherein the second location is fluidly located between the first location and the outlet; and wherein the heating apparatus is configured to cause the heating of the first portion of the aerosolizable material before or more quickly than the heating of the second portion of the aerosolizable material.

In an exemplary embodiment, the heating apparatus comprises: a first heating unit that is operable to cause the heating of the first portion of the aerosolizable material, a second heating unit that is operable to cause the heating of the second portion of the aerosolizable material, and a controller that is configured to cause operation of the first and second heating units to cause the heating of the first portion of the aerosolizable material before or more quickly than the heating of the second portion of the aerosolizable material during the heating session.

In an exemplary embodiment, the controller is configured to cause a cessation in the supply of power to the first heating unit, during at least part of a period for which the controller is configured to cause operation of the second heating unit.

A second aspect of the present invention provides an aerosol provision device, comprising: a heating zone for receiving at least a portion of an article comprising aerosolizable material; an outlet through which aerosol is deliverable from the heating zone to a user in use; and heating apparatus for causing heating of the article when the article is at least partially located within the heating zone to thereby generate the aerosol, wherein the heating apparatus comprises: a first heating unit that is operable to cause heating of a first portion of the aerosolizable material, that is located at a first location in the heating zone when the article is at least partially located within the heating zone, to a temperature sufficient to aerosolize a component of the first portion of the aerosolizable material without burning the first portion of the aerosolizable material, a second heating unit that is operable to cause heating of a second portion of the aerosolizable material, that is located at a second location in the heating zone when the article is at least partially located within the heating zone, to a temperature sufficient to aerosolize a component of the second portion of the aerosolizable material without burning the second portion of the aerosolizable material, wherein the second location is fluidly located between the first location and the outlet, a third heating unit that is operable to cause heating of a third portion of the aerosolizable material, that is located at a third location in the heating zone when the article is at least partially located within the heating zone, to a temperature sufficient to aerosolize a component of the third portion of the aerosolizable material without burning the third portion of the aerosolizable material, wherein the third location is fluidly located between the second location and the outlet, and a controller that is configured to cause operation of the first, second and third heating units.

In an exemplary embodiment, the controller is configured to cause operation of the heating units independently of each other.

In an exemplary embodiment, the third heating unit is located between the second heating unit and the outlet.

In an exemplary embodiment, the second heating unit is located between the first heating unit and the outlet.

In an exemplary embodiment, the heating apparatus comprises at least one further heating unit that is operable to cause heating of a further respective portion of the aerosolizable material, that is located at a further respective location in the heating zone when the article is at least partially located within the heating zone, to a temperature sufficient to aerosolize a component of the further respective portion of the aerosolizable material without burning the further respective portion of the aerosolizable material.

In an exemplary embodiment, the heating units comprise respective resistive heating units.

In an exemplary embodiment, the heating units comprise respective induction heating units that are configured to generate respective varying magnetic fields.

In an exemplary embodiment, each of the induction heating units comprises an inductor that comprises a respective electrically-conductive element, and wherein each of the electrically-conductive elements comprises: an electrically-conductive non-spiral first portion coincident with a first plane, an electrically-conductive non-spiral second portion coincident with a second plane that is spaced from the first plane, and an electrically-conductive connector that electrically connects the first portion to the second portion.

In an exemplary embodiment, the second plane is parallel to the first plane.

In an exemplary embodiment, the first portion is a first partial annulus such as a first circular arc, and the second portion is a second partial annulus such as a second circular arc.

In an exemplary embodiment, each of the electrically-conductive elements of the respective inductors at least partially encircles the heating zone.

In an exemplary embodiment, the aerosol provision device comprises a susceptor that is configured so as to be heatable by penetration with the varying magnetic fields to thereby cause heating of the heating zone.

In an exemplary embodiment, the susceptor has a thermal conductivity of at least 10 W/m/K.

In an exemplary embodiment, the article comprising aerosolizable material is insertable at least partially into the heating zone via the outlet.

A third aspect of the present invention provides an aerosol provision system, comprising the aerosol provision device according to the first or second aspect of the present invention, and the article comprising aerosolizable material, wherein the article is at least partially insertable into the heating zone so that the first and second portions of the aerosolizable material are respectively located at the first and second locations in the heating zone.

In an exemplary embodiment, the article is at least partially insertable into the heating zone so that the third portion of the aerosolizable material is located at the third location in the heating zone.

In an exemplary embodiment, the article comprising aerosolizable material is at least partially insertable into the heating zone via the outlet.

In an exemplary embodiment, each of the first and second portions of the aerosolizable material is between 4 millimeters and 6 millimeters in length.

In an exemplary embodiment, the article is dimensioned so as to protrude from the heating zone through the outlet during the heating session.

A fourth aspect of the present invention provides a method of heating aerosolizable material during a heating session using an aerosol provision device that comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol; the method comprising: the heating apparatus causing, when the article is at least partially located within the heating zone, heating of a first portion of the aerosolizable material of the article to a temperature sufficient to aerosolize a component of the first portion of the aerosolizable material without burning the first portion of the aerosolizable material before or more quickly than heating of a second portion of the aerosolizable material of the article to a temperature sufficient to aerosolize a component of the second portion of the aerosolizable material without burning the second portion of the aerosolizable material, wherein the second portion of the aerosolizable material is fluidly located between the first portion of the aerosolizable material and the outlet.

A fifth aspect of the present invention provides a method of heating aerosolizable material during a heating session using an aerosol provision device that comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol, wherein the heating apparatus comprises a first heating unit, a second heating unit, a third heating unit and a controller; the method comprising the controller controlling the first, second and third heating units independently of each other to cause, when the article is at least partially located within the heating zone: the first heating unit to heat a first portion of the aerosolizable material of the article to a temperature sufficient to aerosolize a component of the first portion of the aerosolizable material without burning the first portion of the aerosolizable material; the second heating unit to heat a second portion of the aerosolizable material of the article to a temperature sufficient to aerosolize a component of the second portion of the aerosolizable material; and the third heating unit to heat a third portion of the aerosolizable material of the article to a temperature sufficient to aerosolize a component of the third portion of the aerosolizable material; wherein the second portion of the aerosolizable material is fluidly located between the first portion of the aerosolizable material and the outlet, and the third portion of the aerosolizable material is fluidly located between the second portion of the aerosolizable material and the outlet.

A sixth aspect of the present invention provides an aerosol provision device that is configured to perform the method of the fourth or fifth aspect of the present invention.

### BRIEF DESCRIPTION OF THE DRAWINGS

Embodiments of the invention will now be described, by way of example only, with reference to the accompanying drawings, in which:

FIG. 1 shows a schematic side view of an example of an aerosol provision system;

FIG. 2 is a flow diagram showing an example of a method of heating aerosolizable material;

FIG. 3 is a flow diagram showing another example of a method of heating aerosolizable material;

FIG. 4 shows a schematic cross-sectional side view of an inductor arrangement of an aerosol provision device of the system of FIG. 1; and

FIG. 5 shows a schematic perspective view of an inductor of the inductor arrangement of FIG. 4.

### DETAILED DESCRIPTION

As used herein, the term “aerosolizable material” includes materials that provide volatilized components upon heating, typically in the form of vapor or an aerosol. “Aerosolizable material” may be a non-tobacco-containing material or a tobacco-containing material. “Aerosolizable material” may, for example, include one or more of tobacco per se, tobacco derivatives, expanded tobacco, reconstituted tobacco, tobacco extract, homogenized tobacco or tobacco substitutes. The aerosolizable material can be in the form of ground tobacco, cut rag tobacco, extruded tobacco, reconstituted tobacco, reconstituted aerosolizable material, liquid, gel, a solid, an amorphous solid, gelled sheet, powder, beads, granules, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

In some examples, the aerosolizable material is in the form of an “amorphous solid”. Any material referred to herein as an “amorphous solid” may alternatively be referred to as a “monolithic solid” (i.e. non-fibrous), or as a “dried gel”. It some cases, it may be referred to as a “thick film”. In some examples, the amorphous solid may consist essentially of, or consist of, a gelling agent, an aerosol generating agent, a tobacco material and/or a nicotine source, water, and optionally a flavor. In some examples, the gel or amorphous solid takes the form of a foam, such as an open celled foam.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

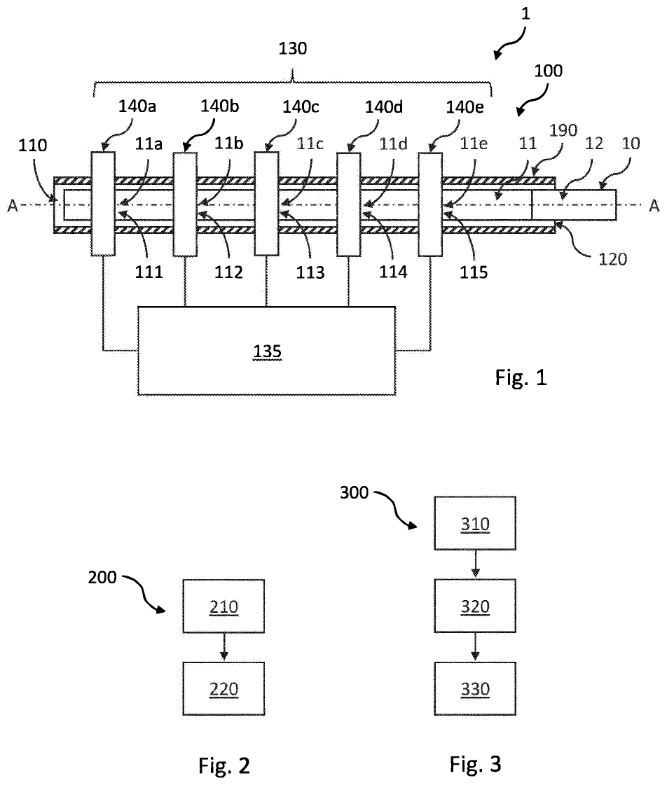

Referring to FIG. 1, there is shown a schematic cross-sectional side view of an example of an aerosol provision system. The system 1 comprises an aerosol provision device 100 and an article 10 comprising aerosolizable material 11. The aerosolizable material 11 may, for example, be of any of the types of aerosolizable material discussed herein. In this example, the aerosol provision device 100 is a tobacco heating product (also known in the art as a tobacco heating device or a heat-not-burn device).

In some examples, the aerosolizable material 11 is a non-liquid material. In some examples, the aerosolizable material 11 is a gel. In some examples, the aerosolizable material 11 comprises tobacco. However, in other examples, the aerosolizable material 11 may consist of tobacco, may consist substantially entirely of tobacco, may comprise tobacco and aerosolizable material other than tobacco, may comprise aerosolizable material other than tobacco, or may be free from tobacco. In some examples, the aerosolizable material 11 may comprise a vapor or aerosol forming agent or a humectant, such as glycerol, propylene glycol, triacetin, or diethylene glycol. In some examples, the aerosolizable material 11 comprises reconstituted aerosolizable material, such as reconstituted tobacco.

In some examples, the aerosolizable material 11 is substantially cylindrical with a substantially circular cross section and a longitudinal axis. In other examples, the aerosolizable material 11 may have a different cross-sectional shape and/or not be elongate.

The aerosolizable material 11 of the article 10 may, for example, have an axial length of between 8 mm and 120 mm. For example, the axial length of the aerosolizable material 11 may be greater than 9 mm, or 10 mm, or 15 mm, or 20 mm. For example, the axial length of the aerosolizable material 11 may be less than 100 mm, or 75 mm, or 50 mm, or 40 mm.

In some examples, such as that shown in FIG. 1, the article 10 comprises a filter arrangement 12 for filtering aerosol or vapor released from the aerosolizable material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

In some examples, the filter arrangement 12 abuts a longitudinal end of the aerosolizable material 11. In other examples, the filter arrangement 12 may be spaced from the aerosolizable material 11, such as by a gap and/or by one or more further components of the article 10. In some examples, the filter arrangement 12 may comprise an additive or flavor source (such as an additive- or flavor-containing capsule or thread), which may be held by a body of filtration material or between two bodies of filtration material, for example.

The article 10 may also comprise a wrapper (not shown) that is wrapped around the aerosolizable material 11 and the filter arrangement 12 to retain the filter arrangement 12 relative to the aerosolizable material 11. The wrapper may be wrapped around the aerosolizable material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosolizable material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating.

In other examples, the adhesive may be omitted or the wrapper may take a different from to that described. In other examples, the filter arrangement 12 may be retained relative to the aerosolizable material 11 by a connector other than a wrapper, such as an adhesive. In some examples, the filter arrangement 12 may be omitted.

The aerosol provision device 100 comprises a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, such as that shown in FIG. 1, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The device 100 may define at least one air inlet (not shown) that fluidly connects the heating zone 110 with an exterior of the device 100. A user may be able to inhale the volatilized component(s) of the aerosolizable material by drawing the volatilized component(s) from the heating zone 110 via the article 10. As the volatilized component(s) are removed from the heating zone 110 and the article 10, air may be drawn into the heating zone 110 via the air inlet(s) of the device 100.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the device 100 may include a mouthpiece that can be arranged to cover the outlet 120 and through which the aerosol can be drawn from the heating zone 110 and the article 10.

In this example, when the article 10 is at least partially located within the heating zone 110, different portions 11a-11e of the aerosolizable material 11 are located at different respective locations 110a-110e in the heating zone 110. In this example, these locations 110a-110e are at different respective axial positions along the axis A-A of the heating zone 110. Moreover, in this example, since the heating zone 110 is elongate, the locations 110a-110e can be considered to be at different longitudinally-spaced-apart positions along the length of the heating zone 110. In this example, the article 10 can be considered to comprise five such portions 11a-11e of the aerosolizable material 11 that are located respectively at a first location 110a, a second location 110b, a third location 110c, a fourth location 110d and a fifth location 110e. More specifically, the second location 110b is fluidly located between the first location 110a and the outlet 120, the third location 110c is fluidly located between the second location 110b and the outlet 120, the fourth location 110d is fluidly located between the third location 110c and the outlet 120, and the fifth location is fluidly located between the fourth location 110d and the outlet 120.

The heating apparatus 130 comprises plural heating units 140a-140e, each of which is able to cause heating of a respective one of the portions 11a-11e of the aerosolizable material 11 to a temperature sufficient to aerosolize a component thereof, when the article 10 is at least partially located within the heating zone 110. The plural heating units 140a-140e may be axially-aligned with each other along the axis A-A. Each of the portions 11a-11e of the aerosolizable material 11 heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosolizable material 11 that are heatable by the respective heating unit(s) may be correspondingly varied.

The heating apparatus 130 also comprises a controller 135 that is configured to cause operation of the heating units 140a-140e to cause the heating of the respective portions 11a-11e of the aerosolizable material 11 in use. In this example, the controller 135 is configured to cause operation of the heating units 140a-140e independently of each other, so that the respective portions 11a-11e of the aerosolizable material 11 can be heated independently. This may be desirable in order to provide progressive heating of the aerosolizable material 11 in use. Moreover, in examples in which the portions 11a-11e of the aerosolizable material 11 have different respective forms or characteristics, such as different tobacco blends and/or different applied or inherent flavors, the ability to independently heat the portions 11a-11e of the aerosolizable material 11 can enable heating of selected portions 11a-11e of the aerosolizable material 11 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective induction heating units that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors 150 of the respective heating units 140a-140e. Moreover, in this example, the device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosolizable material 11 at the respective locations 110a-110e in the heating zone 110.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosolizable material 11. Each of the plural susceptors may be tubular or take one of the other forms discussed herein for the susceptor 190, for example. In still further examples, the device 100 may be free from the susceptor 190, and the article 10 may comprise one or more susceptors that are heatable by penetration with the varying magnetic fields to thereby cause heating of the respective portions 11a-11e of the aerosolizable material 11. Each of the one or more susceptors of the article 10 may take any suitable form, such as a structure (e.g. a metallic foil, such as an aluminum foil) wrapped around or otherwise encircling the aerosolizable material 11, a structure located within the aerosolizable material 11, or a group of particles or other elements mixed with the aerosolizable material 11. In examples in which the device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the inductor 150 of at least one of the respective heating units 140a-140e. This causes the inductor 150 to generate an alternating magnetic field. The inductor 150 and the susceptor 190 are suitably relatively positioned so that the varying magnetic field produced by the inductor 150 penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article 10, respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosolizable material 11 within the article 10 located in the heating chamber 110 is heated sufficiently to volatilize at least one component of the aerosolizable material 11 without combusting the aerosolizable material 11. Accordingly, the controller 135, and the device 100 as a whole, is arranged to heat the aerosolizable material 11 to volatilize the at least one component of the aerosolizable material 11 without combusting the aerosolizable material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

Further discussion of the form of each of the heating units 140a-140e will be given below with reference to FIGS. 2 and 3. However, what is notable at this stage is that the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosolizable material 11 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 11a-11e of the aerosolizable material 11 may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

In this example, the heating apparatus 130 is configured to cause heating of the first portion 11a of the aerosolizable material 11 to a temperature sufficient to aerosolize a component of the first portion 11a of the aerosolizable material 11 before or more quickly than the heating of the second portion 11b of the aerosolizable material 11 during a heating session. More specifically, the controller 135 is configured to cause operation of the first and second heating units 140a, 140b to cause the heating of the first portion 11a of the aerosolizable material 11 before or more quickly than the heating of the second portion 11b of the aerosolizable material 11 during the heating session. Accordingly, during the heating session, the position at which heat energy is applied to the aerosolizable material 11 of the article 10 is initially relatively fluidly spaced from the outlet 120 and the user, and then moves towards the outlet 120. This provides the benefit that during a heating session aerosol is generated from successive “fresh” portions of the aerosolizable material 11, which can lead to a sensorially-satisfying experience for the user that may be more similar to that had when smoking a traditional combustible factory-made cigarette.

Moreover, in some examples, the controller 135 is configured to cause a cessation in the supply of power to the first heating unit 140a, during at least part of a period (or all of the period) for which the controller 135 is configured to cause operation of the second heating unit 140b. This provides the further benefit that aerosol generated in a given portion of the aerosolizable material 11 need not pass through another portion of the aerosolizable material 11 that has previously been heated, which could otherwise negatively impact the aerosol. For example, aerosol passing through previously-heated or spent aerosolizable material can result in the aerosol picking-up components that provide the aerosol with “off-notes”.

In some examples in which the heating apparatus 130 has more than two heating units, such as the example shown in FIG. 1, during the heating session the heating apparatus 130 may also be configured to cause heating of at least one further portion 11b-11e of the aerosolizable material 11 to a temperature sufficient to aerosolize a component of the further portion 11b-11e of the aerosolizable material 11 before or more quickly than the heating of a still further portion 11c-11e of the aerosolizable material 11 that is fluidly closer to the outlet 120. That is, the controller 135 may be configured to cause suitable operation of the heating units to cause the heating of the at least one further portion 11b-11e of the aerosolizable material 11 before or more quickly than the heating of the still further portion 11c-11e of the aerosolizable material 11. For example, in the device of FIG. 1, the heating apparatus 130 may be configured to cause:
heating of the second portion 11b of the aerosolizable material 11 to a temperature sufficient to aerosolize a component of the second portion 11b of the aerosolizable material 11 before or more quickly than the heating of the third portion 11c of the aerosolizable material 11,
heating of the third portion 11c of the aerosolizable material 11 to a temperature sufficient to aerosolize a component of the third portion 11c of the aerosolizable material 11 before or more quickly than the heating of the fourth portion 11d of the aerosolizable material 11, and
heating of the fourth portion 11d of the aerosolizable material 11 to a temperature sufficient to aerosolize a component of the fourth portion 11d of the aerosolizable material 11 before or more quickly than the heating of the fifth portion 11e of the aerosolizable material 11.

It will be understood that, for a given duration of heating session, the greater the number of heating units and associated portions of the aerosolizable material 11 there are, the greater the opportunity to generate aerosol from “fresh” or unspent portions of the aerosolizable material 11 extending along a given axial length. Alternatively, for a given duration of heating each portion of the aerosolizable material 11, the greater the number of heating units and associated portions of the aerosolizable material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

Referring to FIG. 2, there is shown a flow diagram showing an example of a method of heating aerosolizable material during a heating session using an aerosol provision device. The aerosol provision device used in the method 200 comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol. The aerosol provision device may, for example, be that which is shown in FIG. 1 or any of the suitable variants thereof discussed herein.

The method 200 comprises the heating apparatus 130 causing, when the article 10 is at least partially located within the heating zone 110, heating 210 of a first portion 11a of the aerosolizable material 11 of the article 10 to a temperature sufficient to aerosolize a component of the first portion 11a of the aerosolizable material 11 before or more quickly than heating 220 of a second portion 11b of the aerosolizable material 11 of the article 10 to a temperature sufficient to aerosolize a component of the second portion 11b of the aerosolizable material 11, wherein the second portion 11b of the aerosolizable material 11 is fluidly located between the first portion 11a of the aerosolizable material 11 and the outlet 120.

It will be understood from the teaching herein that the method 200 could be suitably adapted to comprise the heating apparatus 130 also causing heating of at least one further portion 11b-11e of the aerosolizable material 11 to a temperature sufficient to aerosolize a component of the further portion 11b-11e of the aerosolizable material 11 before or more quickly than the heating of a still further portion 11c-11e of the aerosolizable material 11 that is fluidly closer to the outlet 120, as discussed above.

Referring to FIG. 3, there is shown a flow diagram showing another example of a method of heating aerosolizable material during a heating session using an aerosol provision device. The aerosol provision device used in the method 300 comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol. The heating apparatus comprises a first heating unit, a second heating unit, a third heating unit and a controller that is configured to cause operation of the first, second and third heating units. The aerosol provision device may, for example, be that which is shown in FIG. 1 or any of the suitable variants thereof discussed herein.

The method 300 comprises the controller 135 controlling the first, second and third heating units 140a, 140b, 140c independently of each other to cause, when the article 10 is at least partially located within the heating zone 110: the first heating unit 140a to heat 310a first portion 11a of the aerosolizable material 11 of the article 10 to a temperature sufficient to aerosolize a component of the first portion 11a of the aerosolizable material 11 (e.g. before or more quickly than the second portion 11b); the second heating unit 140b to heat 320a second portion 11b of the aerosolizable material 11 of the article 10 to a temperature sufficient to aerosolize a component of the second portion 11b of the aerosolizable material 11 (e.g. before or more quickly than the third portion 11c); and the third heating unit 140c to heat 330a third portion 11c of the aerosolizable material 11 of the article 10 to a temperature sufficient to aerosolize a component of the third portion 11c of the aerosolizable material 11, wherein the second portion 11b of the aerosolizable material 11 is fluidly located between the first portion 11a of the aerosolizable material 11 and the outlet 120, and the third portion 11c of the aerosolizable material 11 is fluidly located between the second portion 11b of the aerosolizable material 11 and the outlet 120.

When the aerosol provision device used in the method 300 comprises sufficient heating units, it will be understood from the teaching herein that the method 300 could be suitably adapted to comprise the heating apparatus 130 also controlling fourth and fifth heating units 140d, 140e independently of each other to cause, when the article 10 is at least partially located within the heating zone 110: the fourth heating unit 140d to heat a fourth portion 11d of the aerosolizable material 11 of the article 10 to a temperature sufficient to aerosolize a component of the fourth portion 11d of the aerosolizable material 11; and the fifth heating unit 140e to heat a fifth portion 11e of the aerosolizable material 11 of the article 10 to a temperature sufficient to aerosolize a component of the fifth portion 11e of the aerosolizable material 11, wherein the fourth portion 11d of the aerosolizable material 11 is fluidly located between the third portion 11c of the aerosolizable material 11 and the outlet 120, and the fifth portion 11e of the aerosolizable material 11 is fluidly located between the fourth portion 11d of the aerosolizable material 11 and the outlet 120.

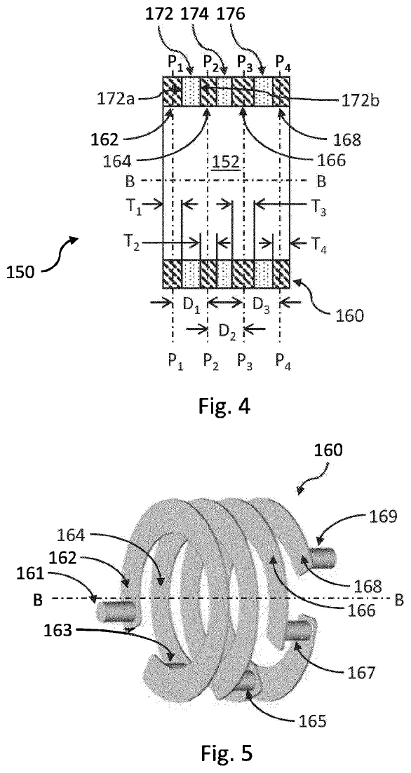

One of the heating units 140a-140e of the heating apparatus 130 will now be described in more detail with reference to FIGS. 4 and 5. These Figures respectively show a schematic cross-sectional side view of an inductor arrangement 150 of the heating unit and a schematic perspective view of an inductor 160 of the inductor arrangement 150.

The inductor arrangement 150 comprises an electrically-insulating support 172 and the inductor 160. The support 172 has opposite first and second sides 172a, 172b, and parts 162, 164 of the inductor 160 are on the respective first and second sides 172a, 172b of the support 172.

More specifically, the inductor 160 comprises an electrically-conductive element 160. The element 160 comprises an electrically-conductive non-spiral first portion 162 that is coincident with a first plane P₁, and an electrically-conductive non-spiral second portion 164 that is coincident with a second plane P₂ that is spaced from the first plane P₁. In this example, the second plane P₂ is parallel to the first plane P₁, but in other examples this need not be the case. For example, the second plane P₂ may be at an angle to the first plane P₁, such as an angle of no more than 20 degrees or no more than 10 degrees or no more than 5 degrees. The inductor 160 also comprises a first electrically-conductive connector 163 that electrically connects the first portion 162 to the second portion 164. The first portion 162 is on the first side 172a of the support 172, and the second portion 164 is on the second side 172b of the support 172. The electrically conductive connector 163 passes through the support 172 from the first side 172a to the second side 172b. The electrically conductive connector 163 may have the structure of plating (e.g., copper plating) on the surface of a through hole provided in the support 172.

The support 172 can be made of any suitable electrically-insulating material(s). In some examples, the support 172 comprises a matrix (such as an epoxy resin, optionally with added filler such as ceramics) and a reinforcement structure (such as a woven or non-woven material, such as glass fibers or paper).

The inductor 160 can be made of any suitable electrically-conductive material(s). In some examples, the inductor 160 is made of copper.

In some examples, the inductor arrangement 150 comprises, or is formed from, a PCB. In such examples, the support 172 is a non-electrically-conductive substrate of the PCB, which may be formed from materials such as FR-4 glass epoxy or cotton paper impregnated with phenolic resin, and the first and second portions 162, 164 of the inductor 160 are tracks on the substrate. This facilitates manufacture of the inductor arrangement 150, and also enables the portions 162, 164 of the element 160 to be thin and closely spaced, as discussed in more detail below.

In this example, the first portion 162 is a first partial annulus 162 and the second portion 164 is a second partial annulus 164. Moreover, in this example, each of the first and second portions 162, 164 follows only part of a respective circular path. Therefore, the first portion or first partial annulus 162 is a first circular arc, and the second portion or second partial annulus 164 is a second circular arc. In other examples, the first and second portions 162, 164 may follow a path that is other than circular, such as elliptical, polygonal or irregular. However, matching the shape of the first and second portions 162, 164 to the shape (or at least an aspect of the shape, such as outer perimeter) of respective adjacent portions of the susceptor 190 (whether provided in the device 100 or the article 10) helps lead to improved and more consistent magnetic coupling of the inductor 160 and the susceptor 190. Moreover, in examples in which the first and second portions 162, 164 are respective circular arcs, providing that the radii of the circular arcs are equal also can help lead to the generation of a more consistent magnetic field along the length of the inductor 160, and thus more consistent heating of the susceptor 190.

The inductor arrangement 150 has a through-hole 152 that is radially-inward of, and coaxial with, the first and second portions 162, 164 or partial annuli. In the assembled device 100, the susceptor 190 and the heating zone 110 extend through the through-hole 152, so that the portions 162, 164 of the element 160 together at least partially encircle the susceptor 190 and the heating zone 110. In examples in which the susceptor 190 is replaced by plural susceptors, each of the plural susceptors may be located so as to extend through the through-holes 152 of one or more inductor arrangements 150 of the respective heating units 140a.-140e. In some examples, the or each susceptor does not extend through the through-holes 152, but rather is adjacent (e.g. axially) the associated element 160.

In examples in which the heating apparatus 130 is free from a susceptor, as discussed above, the heating zone 110 may still nevertheless extend through some or all of the through-holes 152 of the inductor arrangements 150 of the respective heating units 140a.-140e. In some such examples, the article 10 comprises one or more susceptors, such as a metallic foil (e.g. aluminum foil) wrapped around or otherwise encircling the aerosolizable material 11 and/or a susceptor, such as in the form of a pad, at one end of the article 10 axially adjacent the aerosolizable material 11 of the article 10. In some examples, the susceptor of an article 10 comprising liquid or gel or otherwise flowable aerosolizable material may comprise a susceptor (e.g. metallic) in, or coated on, a (e.g. ceramic) wick. In some examples, portions 11a-11e of the aerosolizable material 11 have the same respective forms or characteristics, or have different respective forms or characteristics, such as different tobacco blends and/or different applied or inherent flavors. In some such examples, the article 10 may comprise plural susceptors, each of which is arranged and heatable to heat a respective one of the portions 11a-11e of the aerosolizable material 11. In some examples, the portions 11a-11e of the aerosolizable material 11 are isolated from each other. In other examples, there may be plural heating zones, each of which is located between a pair of the inductor arrangements 150. Some or all of the plural heating zones may not extend through the through-holes 152. The plural heating zones may be for receiving respective articles 10 comprising aerosolizable material 11. The aerosolizable material 11 of the respective articles 10 may be of the same or different respective forms or characteristics. In some examples, the through-holes 152 may be omitted.

As may best be understood from further consideration of FIG. 5, when viewed in a direction orthogonal to the first plane P₁, and thus in the direction of an axis B-B of the inductor 160, the first and second portions 162, 164 extend in opposite senses of rotation from the first electrically-conductive connector 163. For example, were one to view the inductor 160 of FIG. 5 in the direction of the axis B-B from left to right as FIG. 5 is drawn, then the first portion 162 of the inductor 160 would extend in an anticlockwise direction from the connector 163, whereas the second portion 164 of the inductor 160 would extend in a clockwise direction from the connector 163.

Moreover, in this example, when viewed in the direction orthogonal to the first plane P₁, the first portion 162 or first partial annulus overlaps, albeit only partially, the second portion 164 or second partial annulus. In this example, the first and second portions 162, 164 together define about 1.75 turns about the axis B-B that is orthogonal to the first and second planes P₁, P₂. In other examples, the number of turns may be other than 1.75, such as another number that is at least 0.9. For example, the number of turns may be between 0.9 and 1.5, or between 1 and 1.25. In other examples, the number of turns may be less than 0.9, although decreasing the number of turns per support 172 may lead to an increase in the axial length of the inductor assembly 150.

Furthermore, when viewed in the direction orthogonal to the first plane P₁, the first portion 162 or first partial annulus, as well as the second portion 164 or second partial annulus, at least partially overlaps the first electrically-conductive connector 163. This is facilitated by the inductor arrangement 150 comprising, or being formed from, a PCB (or more generally, a planar substrate layer). In particular, in such examples, the first electrically-conductive connector 163 takes the form of a “via” that extends through the support 172. Even in examples in which the inductor arrangement 150 is not formed from a PCB, the connector 163 still may extend through the support 172. This overlapped arrangement enables the inductor 160 to occupy a relatively small footprint, when viewed in the direction orthogonal to the first plane P₁, as compared to a comparative example in which the first and second portions 162, 164 are connected by a connector 163 that is spaced radially outwards of the first and second portions 162, 164. Furthermore, this overlapped arrangement enables the width of the through-hole 152 to be increased, as compared to a comparative example in which the first and second portions 162, 164 are connected by a connector 163 that is spaced radially inwards of the first and second portions 162, 164. Nevertheless, in some examples, the connector 163 may be radially-inward or radially-outward of the first and second portions 162, 164. This may be effected by the connector 163 being formed by a “through via” that extends through the support 172. Through vias tend to be cheaper to form than blind vias, as they can be formed after the PCB has been manufactured.

It will be noted that, in this example, the inductor arrangement 150 comprises two further supports 174, 176, and the element 160 comprises two further electrically-conductive non-spiral portions 166, 168 that are coincident with two respective spaced-apart planes P₃, P₄ that are parallel to the first plane P₁. In other examples, one or each of the spaced-apart planes P₃, P₄ may be at an angle to the first plane P₁, such as an angle of no more than 20 degrees or no more than 10 degrees or no more than 5 degrees. The second and third electrically-conductive non-spiral portions 164, 166 are on opposite sides of the second support 174, and are electrically connected by a second electrically-conductive connector 165. The third and fourth electrically-conductive non-spiral portions 166, 168 are on opposite sides of the third support 176, and are electrically connected by a third electrically-conductive connector 167. The second and third electrically-conductive connectors 165, 167 are rotationally offset from the first electrically-conductive connector 163. In arrangements in which the supports 172, 174 and 176 are formed as a PCB, the connectors 163 and 167 may be formed as “blind vias”, while connector 165 may be formed as a “buried via”.

In this example, the first, second, third and fourth portions or partial annuli 162, 164, 166, 168 together define a total of about 3.6 turns about the axis B-B that is orthogonal to the first and second planes P₁, P₂. In other examples, the total number of turns may be other than 3.6, such as another number that is between 1 and 10. For example, the total number of turns may be between 1 and 8, or between 1 and 4. Having a relatively small total number of turns is thought to increase the voltage that will be available in the susceptor 190 (whether provided in the device 100 or the article 10) for forcing electrical current along or around the susceptor 190.

It will be noted that the inductor 160 also comprises first and second terminals 161, 169 at opposite ends of the inductor 160. These terminals are for the passage of electrical current through the inductor 160 in use.

In this example, each of the first, second and third supports 172, 174, 176 has a thickness of about 0.85 millimeters. In some examples, one or more of the supports 172, 174, 176 may have a thickness other than 0.85 millimeters, such as another thickness lying in the range of 0.2 millimeters to 2 millimeters. For example, each of the thicknesses may be between 0.5 millimeters and 1 millimeter, or between 0.75 millimeters and 0.95 millimeters. In some examples, the thicknesses of the respective supports 172, 174, 176 are equal to each other, or substantially equal to each other. In other examples, one or more of the supports 172, 174, 176 may have a thickness that differs from a thickness of one or more of the other supports 172, 174, 176.

In this example, each of the portions 162, 164, 166, 168 of the inductor 160 has a thickness, measured in a direction orthogonal to the first plane P₁, of about 142 micrometers. In some examples, one or more of the portions 162, 164, 166, 168 of the inductor 160 may have a thickness other than 142 micrometers, such as another thickness lying in the range of 10 micrometers to 200 micrometer. For example, each of the thicknesses may be between 25 micrometers and 175 micrometers, or between 100 micrometers and 150 micrometers.

In examples in which the inductor arrangement 150 is made from a PCB, the thickness of the material of the inductor 160 may be determined by “plating-up” the material on the substrate, prior to construction of the PCB. Some standard circuit boards have a 1 oz layer of electrically-conductive material, such as copper, on the substrate. A 1 oz layer has a thickness of about 38 micrometers. By plating-up to a 4 oz layer, the thickness is increased to about 142 micrometers. Increasing the thickness makes the structure of the inductor arrangement more robust and reduces system losses due to a commensurate reduction in ohmic losses. Increasing the volume of material of the inductor 160 will increase the heat capacity of the inductor 160, reducing the temperature gain for a given input of heat. This may be beneficial, as it can be used to help ensure that the temperature of the inductor 160 itself in use does not get so high as to cause damage to the structure of the inductor arrangement 150. In some examples, the thicknesses of the respective portions 162, 164, 166, 168 of the inductor 160 are equal to each other, or substantially equal to each other. This can lead to a more consistent heating effect being produced by the different portions of the inductor 160. In other examples, one or more of the portions 162, 164, 166, 168 of the inductor 160 may have a thickness that differs from a thickness of one or more of the other portions 162, 164, 166, 168 of the inductor 160. This may be intentional in some examples, so as to provide an increased heating effect produced by certain portion(s) of the inductor 160 as compared to the heating effect produced by other portion(s) of the inductor 160.

In this example, each of the planes P₁-P₄ is a flat plane, or a substantially flat plane. However, this need not be the case in other examples.

The first and second planes P₁, P₂ are spaced apart by a distance D₁ in the direction of an axis B-B of the inductor 160, as shown in FIG. 5. In this example, the distance D₁ between the first and second planes P₁, P₂ measured in a direction orthogonal to the first and second planes P₁, P₂ is less than 2 millimeters, such as less than 1 millimeter. In other examples, the distance D₁ may be between 1 and 2 millimeters, or more than 2 millimeters, for example.

The combination of the first electrically-conductive connector 163 and the first and second portions 162, 164 of the electrically-conductive element 160 can be considered to be, or to approximate, a helical coil. Indeed, the full inductor 160 can be considered to be, or to approximate, a helical coil.

Given the distances D₁, D₂, D₃ between adjacent pairs of the planes P₁, P₂, P₃, P₄, the coil of this example can be considered to have a pitch of less than 2 millimeters, such as less than 1 millimeter. In other examples, the pitch may be between 1 millimeter and 2 millimeters, or more than 2 millimeters, for example. Optionally, a distance between each adjacent pair of the portions 162, 164, 166, 168 of the element 160 is equal to, or differs by less than 10% from, a distance between each other adjacent pair of the portions 162, 164, 166, 168 of the element 160. This can lead to the generation of a more consistent magnetic field along the length of the inductor 160, and thus more consistent heating of the susceptor 190.

The smaller the pitch, the greater the ratio of magnetic field strength to mass of susceptor 190 (whether provided in the device 100 or the article 10) to which the energy is being applied. However, this needs to be balanced against the negative effects of the “proximity effect”. In particular, as the pitch is reduced, losses due to the proximity effect increase. Therefore, careful pitch selection is required to reduce the losses in the inductor 160 while increasing the energy available for heating the susceptor 190. It has been found that, in some examples, when the inductors 160 and the controller 135 are suitably configured, they cause the generation of a magnetic field having a magnetic flux density of at least 0.01 Tesla. In some examples, the magnetic flux density is at least 0.1 Tesla.

Relatively small pitches are enabled through the manufacture of the inductor arrangement 150 from a PCB. Given the present teaching, the skilled person would be able to conceive of other ways of manufacturing induction coils with a similarly small pitch. However, manufacture of the inductor arrangement 150 from a PCB is likely also to be cheaper than some other ways of manufacturing induction coils, such as by winding Litz wire.

While the inductor arrangement 150 of the example shown in the Figures has three supports 172, 174, 176 and an inductor 160 comprising four portions 162, 164, 166, 168, this need not be the case in other examples. In some examples, the inductor 160 may have more or fewer than four portions, such as only three portions 162, 164, 166 or only two portions 162, 164. In some examples, the inductor arrangement 150 may have more or fewer than three supports, such as only two supports 172, 174 or only one support 172. Indeed, in some examples, the number of supports in the inductor arrangement 150 may be only one, and the number of portions of the inductor 160 may be only two, and those two portions 162, 164 of the inductor 160 would be on opposite sides of the single support 172. It will be understood that the number of electrically-conductive connectors 163, 165, 167 would have to be correspondingly adjusted depending on the number of two portions 162, 164, 166, 168 present in the inductor 160. In some examples, the inductor 160 may be provided without any supports between the portions 162, 164, 166, 168 of the inductor 160. In such examples, it is desirable for the inductor 160 to be of sufficient strength to be self-supporting.

The inductor arrangements 150 of the respective heating units 140a-140e, or the inductors 160 thereof, may be provided in an inductor assembly or a magnetic field generator 130 for inclusion in an aerosol provision device, such as the device 100 of FIG. 1 or any of the variants thereof discussed herein. The inductors 160 of the inductor assembly, magnetic field generator 130 or device 100 may be spaced apart by a distance selected so as to enable heating of a majority or otherwise desired amount of the aerosolizable material 11, while avoiding or reducing interference between the inductors 160. As noted herein, the relatively small pitch of the inductors has been found to result in the generation of a varying magnetic field that is relatively concentrated, so that others of the inductors 160 can be placed relatively closely without suffering too much from interference. Adjacent inductors 160 may be spaced apart by a distance of between 5 millimeters and 50 millimeters, such as a distance of between 10 millimeters and 40 millimeters or a distance of between 15 millimeters and 30 millimeters. Other distances may be employed in other examples.

In some examples, the heating units 140a-140e are heating units other than respective induction heating units, such as respective resistive heating units. In some such examples, the aerosol provision device 100 may be configured to carry out one, or other, or both of the methods 200, 300 of heating aerosolizable material discussed above, or any of the suitable variants thereof discussed herein. In some such examples, the aerosol provision device 100 and/or the article 10 may comprise at least one thermally-conductive element that has a thermal conductivity that is sufficient to increase the proportion of the thermally-conductive element that is heated by thermal conduction as a result of heating by the heating units 140a-140e, so as to correspondingly increase the proportion of the aerosolizable material 11 that is heated by operation of each of the heating units 140a-140e. The, or each, thermally-conductive element may, for example, take the form of any of the suitable susceptors discussed herein, such as a metallic (e.g. aluminum) foil in the article 10 or a metallic (e.g. aluminum) tubular component in the device 100.

Once all, substantially all, or many of the volatilizable component(s) of the aerosolizable material 11 in the article 10 has/have been spent, the user may remove the article 10 from the heating chamber 110 of the device 100 and dispose of the article 10.

In some examples, the article 10 is sold, supplied or otherwise provided separately from the device 100 with which the article 10 is usable. However, in some examples, the device 100 and one or more of the articles 10 may be provided together as a system, such as a kit or an assembly, possibly with additional components, such as cleaning utensils.

In order to address various issues and advance the art, the entirety of this disclosure shows by way of illustration and example various embodiments in which the claimed invention may be practiced and which provide for superior aerosol provision devices, superior aerosol provision systems, and superior methods of heating aerosolizable material. The advantages and features of the disclosure are of a representative sample of embodiments only, and are not exhaustive and/or exclusive. They are presented only to assist in understanding and teach the claimed and otherwise disclosed features. It is to be understood that advantages, embodiments, examples, functions, features, structures and/or other aspects of the disclosure are not to be considered limitations on the disclosure as defined by the claims or limitations on equivalents to the claims, and that other embodiments may be utilized and modifications may be made without departing from the scope and/or spirit of the disclosure. Various embodiments may suitably comprise, consist of, or consist in essence of, various combinations of the disclosed elements, components, features, parts, steps, means, etc. The disclosure may include other inventions not presently claimed, but which may be claimed in future.

1. An aerosol provision device, comprising:
a heating zone for receiving at least a portion of an article comprising aerosolizable material;
an outlet through which aerosol is deliverable from the heating zone to a user in use; and
heating apparatus for causing heating of the article when the article is at least partially located within the heating zone to thereby generate the aerosol;
wherein the heating apparatus is configured to, during a heating session, cause:
heating of a first portion of the aerosolizable material, that is located at a first location in the heating zone when the article is at least partially located within the heating zone, to a temperature sufficient to aerosolize a component of the first portion of the aerosolizable material without burning the first portion of the aerosolizable material, and
heating of a second portion of the aerosolizable material, that is located at a second location in the heating zone when the article is at least partially located within the heating zone, to a temperature sufficient to aerosolize a component of the second portion of the aerosolizable material without burning the second portion of the aerosolizable material, wherein the second location is fluidly located between the first location and the outlet; and
wherein the heating apparatus is configured to cause the heating of the first portion of the aerosolizable material before or more quickly than the heating of the second portion of the aerosolizable material.

2. The aerosol provision device according to claim 1, wherein the heating apparatus comprises:
a first heating unit that is operable to cause the heating of the first portion of the aerosolizable material,
a second heating unit that is operable to cause the heating of the second portion of the aerosolizable material, and
a controller that is configured to cause operation of the first and second heating units to cause the heating of the first portion of the aerosolizable material before or more quickly than the heating of the second portion of the aerosolizable material during the heating session.

3. The aerosol provision device according to claim 2, wherein the controller is configured to cause a cessation in the supply of power to the first heating unit, during at least part of a period for which the controller is configured to cause operation of the second heating unit.

4. An aerosol provision device, comprising:
a heating zone for receiving at least a portion of an article comprising aerosolizable material;
an outlet through which aerosol is deliverable from the heating zone to a user in use; and
heating apparatus for causing heating of the article when the article is at least partially located within the heating zone to thereby generate the aerosol, wherein the heating apparatus comprises:
a first heating unit that is operable to cause heating of a first portion of the aerosolizable material, that is located at a first location in the heating zone when the article is at least partially located within the heating zone, to a temperature sufficient to aerosolize a component of the first portion of the aerosolizable material without burning the first portion of the aerosolizable material,
a second heating unit that is operable to cause heating of a second portion of the aerosolizable material, that is located at a second location in the heating zone when the article is at least partially located within the heating zone, to a temperature sufficient to aerosolize a component of the second portion of the aerosolizable material without burning the second portion of the aerosolizable material, wherein the second location is fluidly located between the first location and the outlet,
a third heating unit that is operable to cause heating of a third portion of the aerosolizable material, that is located at a third location in the heating zone when the article is at least partially located within the heating zone, to a temperature sufficient to aerosolize a component of the third portion of the aerosolizable material without burning the third portion of the aerosolizable material, wherein the third location is fluidly located between the second location and the outlet, and
a controller that is configured to cause operation of the first, second and third heating units.

5. The aerosol provision device according to claim 4, wherein the controller is configured to cause operation of the heating units independently of each other.

6. The aerosol provision device according to claim 4, wherein the third heating unit is located between the second heating unit and the outlet.

7. The aerosol provision device according to claim 2, wherein the second heating unit is located between the first heating unit and the outlet.

8. The aerosol provision device according to claim 2, wherein the heating apparatus comprises at least one further heating unit that is operable to cause heating of a further respective portion of the aerosolizable material, that is located at a further respective location in the heating zone when the article is at least partially located within the heating zone, to a temperature sufficient to aerosolise a component of the further respective portion of the aerosolizable material without burning the further respective portion of the aerosolizable material.

9. The aerosol provision device according to claim 2, wherein the heating units comprise respective induction heating units that are configured to generate respective varying magnetic fields.

10. The aerosol provision device according to claim 9, wherein each of the induction heating units comprises an inductor that comprises a respective electrically-conductive element, and wherein each of the electrically-conductive elements comprises:
an electrically-conductive non-spiral first portion coincident with a first plane,
an electrically-conductive non-spiral second portion coincident with a second plane that is spaced from the first plane, and
an electrically-conductive connector that electrically connects the first portion to the second portion.

11. The aerosol provision device according to claim 10, wherein the first portion is a first partial annulus such as a first circular arc, and the second portion is a second partial annulus such as a second circular arc.

12. The aerosol provision device according to claim 10, wherein each of the electrically-conductive elements of the respective inductors at least partially encircles the heating zone.

13. The aerosol provision device according to claim 9, comprising a susceptor that is configured so as to be heatable by penetration with the varying magnetic fields to thereby cause heating of the heating zone.

14. The aerosol provision device according to claim 13, wherein the susceptor has a thermal conductivity of at least 10 W/m/K.

15. The aerosol provision device according to claim 1, wherein the article comprising aerosolizable material is insertable at least partially into the heating zone via the outlet.

16. An aerosol provision system, comprising the aerosol provision device according to claim 1 and the article comprising aerosolizable material, wherein the article is at least partially insertable into the heating zone so that the first and second portions of the aerosolizable material are respectively located at the first and second locations in the heating zone.

17. The aerosol provision system according to claim 16, wherein the article is at least partially insertable into the heating zone so that the third portion of the aerosolizable material is located at the third location in the heating zone.

18. The aerosol provision system according to claim 16, wherein the article comprising aerosolizable material is at least partially insertable into the heating zone via the outlet.

19. The aerosol provision system according to claim 16, wherein each of the first and second portions of the aerosolizable material is between 4 millimeters and 6 millimeters in length.

20. The aerosol provision system according to claim 16, wherein the article is dimensioned so as to protrude from the heating zone through the outlet during the heating session.

21. A method of heating aerosolizable material during a heating session using an aerosol provision device that comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol; the method comprising:
the heating apparatus causing, when the article is at least partially located within the heating zone, heating of a first portion of the aerosolizable material of the article to a temperature sufficient to aerosolize a component of the first portion of the aerosolizable material without burning the first portion of the aerosolizable material before or more quickly than heating of a second portion of the aerosolizable material of the article to a temperature sufficient to aerosolize a component of the second portion of the aerosolizable material without burning the second portion of the aerosolizable material, wherein the second portion of the aerosolizable material is fluidly located between the first portion of the aerosolizable material and the outlet.

22. A method of heating aerosolizable material during a heating session using an aerosol provision device that comprises a heating zone for receiving at least a portion of an article comprising aerosolizable material, an outlet through which aerosol is deliverable from the heating zone to a user in use, and heating apparatus for causing heating of the article when the article is at least partially located within the heating zone to thereby generate the aerosol, wherein the heating apparatus comprises a first heating unit, a second heating unit, a third heating unit and a controller; the method comprising the controller controlling the first, second and third heating units independently of each other to cause, when the article is at least partially located within the heating zone:
the first heating unit to heat a first portion of the aerosolizable material of the article to a temperature sufficient to aerosolize a component of the first portion of the aerosolizable material without burning the first portion of the aerosolizable material;
the second heating unit to heat a second portion of the aerosolizable material of the article to a temperature sufficient to aerosolize a component of the second portion of the aerosolizable material; and
the third heating unit to heat a third portion of the aerosolizable material of the article to a temperature sufficient to aerosolize a component of the third portion of the aerosolizable material;
wherein the second portion of the aerosolizable material is fluidly located between the first portion of the aerosolizable material and the outlet, and the third portion of the aerosolizable material is fluidly located between the second portion of the aerosolizable material and the outlet.

23. An aerosol provision device that is configured to perform the method of claim 21.

24. An aerosol provision device that is configured to perform the method of claim 22.
